(19) United States
(12) Patent Application Publication
(10) Pub. No.: US 2020/0207581 A1
(43) Pub. Date: Jul. 2, 2020

(54) ELEVATOR SAFETY DEVICE

(71) Applicant: Otis Elevator Company, Farmington, CT (US)

(72) Inventor: Javier Munoz Sotoca, Madrid (ES)

(21) Appl. No.: 16/725,604

(22) Filed: Dec. 23, 2019

(30) Foreign Application Priority Data
Jan. 2, 2019 (EP) 19150084.2

(51) Int. Cl. B66B 5/20; B66B 7/04; B66B 5/28

(52) U.S. Cl. CPC B66B 5/20; B66B 5/284; B66B 7/046

(57) ABSTRACT

An actuation device (24) for an elevator safety device (20) configured for moving in a longitudinal direction along a guide member (14, 15) of an elevator system (2), comprises a base (25) and a lever (26). The lever (26) is pivotably supported by the base (25) in a configuration allowing the lever (26) to pivot between an engaged position, in which at least a portion of the lever (26) or an element (27, 46) moving concurrently with the lever (26) contacts the guide member (14, 15); and a disengaged position, in which neither the lever (26) nor an element (27, 46) moving concurrently with the lever (26) contacts the guide member (14, 15). The lever (26) is also shiftable with respect to the base (25).

### FOREIGN PRIORITY

This application claims priority to European Patent Application No. 19150084.2, filed Jan. 2, 2019, and all the benefits accruing therefrom under 35 U.S.C. § 119, the contents of which in its entirety are herein incorporated by reference.

### BACKGROUND

The invention relates to an actuation device and to an elevator safety device comprising such an actuation device. The invention further relates to an elevator car and to an elevator counterweight respectively comprising such an elevator safety device; it also relates to an elevator system comprising such an elevator car and/or such a counterweight.

An elevator system typically comprises at least one elevator car moving along a hoistway extending between a plurality of landings, and a driving member configured for driving the elevator car. In particular embodiments, the elevator system may further include a counterweight moving concurrently and in opposite direction with respect to the elevator car. In order to ensure safe operation, the elevator system further comprises at least one elevator safety device. The at least one elevator safety device is configured for braking the movement of the elevator car and/or the counterweight relative to a guide member, such as a guide rail, in an emergency situation, for example when the movement of the elevator car and/or the counterweight exceeds a predetermined speed or acceleration.

An elevator safety device typically includes a braking device configured for braking the movement of the elevator car and/or the counterweight, and an actuation device configured for actuating the braking device.

It would be beneficial to provide an improved and reliable elevator safety device which may be produced easier and at lower costs than conventional elevator safety devices.

### SUMMARY

According to an exemplary embodiment of the invention, an actuation device for an elevator safety device, which is configured for moving in a longitudinal direction along a guide member of an elevator system, comprises a base and a lever. The lever is pivotably supported by the base. The lever in particular is supported by the base in a configuration which allows the lever to pivot between an engaged position, in which at least a portion of the lever or an element moving concurrently with the lever contacts the guide member; and a disengaged position, in which neither the lever nor an element moving concurrently with the lever contacts the guide member. Additionally, the lever is shiftable with respect to the base.

A configuration according to an exemplary embodiment of the invention allows the lever to follow a linear movement of the guide member when moving with respect to the base. Such a movement occurs when the actuation device moves with respect to the guide member. In consequence, an engaging contact between the lever or an element moving concurrently with the lever may be maintained even when the actuation device moves with respect to the guide member.

Exemplary embodiments of the invention also include an elevator safety device comprising an actuation device according to an exemplary embodiment of the invention, and a braking device coupled with the actuation device and configured for braking movement of the elevator safety device with respect to the guide member. In such an elevator safety device, the actuation device is configured for actuating the braking device.

Exemplary embodiments of the invention further include an elevator safety device comprising an actuation device according to an exemplary embodiment of the invention and at least one guide configured for pressing a portion of the lever against the guide member when the lever is arranged in the engaged position and the elevator safety device moves with respect to the guide member. Such a configuration allows providing a very compact elevator safety device which occupies less space than an elevator safety device comprising an actuation device which is separated from the braking device.

Exemplary embodiments of the invention also include a movable component of an elevator system, such as an elevator car or a counterweight, equipped with such an elevator safety system. Exemplary embodiments of the invention further include an elevator system comprising a movable component equipped with an elevator safety system according to an exemplary embodiment of the invention.

A number of optional features are set out in the following. These features may be realized in particular embodiments, alone or in combination with any of the other features, unless specified otherwise.

The lever may be supported by a fulcrum which is linearly shiftable with respect to the base, in particular in a direction oriented basically parallel to the longitudinal direction. Such a configuration allows the lever to follow a linear movement of the guide member with respect to the base as it occurs when the actuation device moves along the guide member in the longitudinal direction.

The actuation device may comprise at least one elastic element, such as a spring, which is configured for urging the lever into the engaged position. An elastic element, such as spring, provides a simple and durable means for urging the lever into the engaged position. It further allows adjusting the actuation device to different types of elevator systems, in particular to different maximum speeds and duty loads of the movable component, by selecting an appropriate elastic element.

A first end of the elastic element may be mounted to the lever, and a second, opposing end of the elastic element may be mounted to a carriage which is movably supported with respect to the base in order to allow the elastic element to move concurrently with the lever in the longitudinal direction. The actuation device in particular may comprise a roller bearing or a slide bearing for supporting the carriage in a configuration which allows the carriage to move with respect to the base. Such a configuration allows the elastic element to maintain the elastic force urging the lever into the engaged position even when the lever moves with respect to the base in the longitudinal direction.

The actuation device may further comprise at least one actuator configured for moving and/or holding the lever, in particular for selectively moving and/or holding the lever into/in the disengaged position. The at least one actuator may comprise an electromagnet configured for moving and/or holding the lever by means of an electromagnetic force generated by the electromagnet. An electromagnetic actuator provides a reliable means for selectively moving the lever between its engaged and disengaged positions.

The at least one guide configured for pressing a portion of the lever against the guide member may extend in a direction which is inclined with respect to the longitudinal direction, thereby providing a wedge like configuration resulting in very good braking capabilities of the safety device.

The elevator safety device may comprise a roller rotatably attached to the lever and configured for rolling along the at least one guide. A roller configured for rolling along a guide provides very efficient means generating a braking force between the elevator safety device and the guide member.

At least a portion of the at least one guide may have elastic properties. The at least one guide in particular may comprise an elastic element, such as a leaf spring, configured for elastically pressing the roller against the guide. A guide member having elastic properties results in a smooth built-up of the braking force when the elevator safety device is activated.

In order to enhance the braking force, the actuation device may comprise a brake pad arranged in a configuration sandwiching the guide member between the element moving concurrently with the lever and the brake pad. Such a configuration allows squeezing the guide member between the lever and the brake pad by moving the lever into the engaged position. In order to enhance the braking force even further, a brake lining may be provided at least to the side of the brake pad facing the guide member.

Exemplary embodiments of the invention allow for more durability and modularity than conventional actuation devices.

In an elevator safety device comprising an actuation device according to an exemplary embodiment of the invention, the friction lining is urged against the guide member by means of an elastic element, such as a spring. This allows applying a regular frictional force which is easy to calculate and implement.

Exemplary embodiments of the invention in particular allow adjusting the elevator safety device easily to different types of elevator systems, in particular to different maximum speeds and duty loads of the movable component, e.g. by replacing the elastic element.

### DRAWING DESCRIPTION

In the following, exemplary embodiments of the invention are described in more detail with respect to the enclosed figures:

FIG. 1 schematically depicts an elevator system with an elevator safety device according to an exemplary embodiment of the invention.

FIG. 2 depicts a perspective view of an elevator car comprising an elevator safety device according to an exemplary embodiment of the invention.

FIG. 3 depicts a plane view of the elevator safety device according to an embodiment of the invention in a disengaged state.

FIG. 4 depicts a plane view of an actuation device of the elevator safety device depicted in FIG. 3 in an engaged (activated) state.

FIG. 5 depicts an embodiment of an elevator safety device according to another exemplary embodiment of the invention.

### DETAILED DESCRIPTION

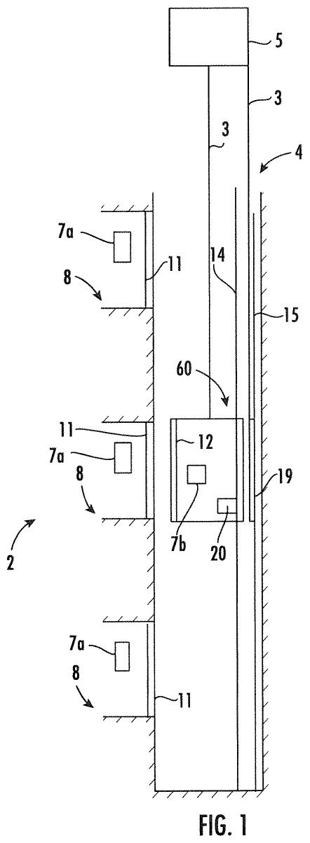

FIG. 1 schematically depicts an elevator system 2 according to an exemplary embodiment of the invention.

The elevator system 2 includes an elevator car 60 movably arranged within a hoistway 4 extending between a plurality of landings 8. The elevator car 60 in particular is movable in a longitudinal (vertical) direction along a plurality of car guide members 14, such as guide rails, extending along the vertical direction of the hoistway 4. Only one of said car guide members 14 is depicted in FIG. 1.

Although only one elevator car 60 is shown in FIG. 1, the skilled person understands that exemplary embodiments of the invention may include elevator systems 2 including a plurality of elevator cars 60 moving in one or more hoistways 4.

The elevator car 60 is movably suspended by means of a tension member 3. The tension member 3, for example a rope or belt, is connected to a drive unit 5, which is configured for driving the tension member 3 in order to move the elevator car 60 along the height of the hoistway 4 between the plurality of landings 8, which are located on different floors.

The exemplary embodiment shown in FIG. 1 uses a 1:1 roping for suspending the elevator car 60. The skilled person, however, easily understands that the type of the roping is not essential for the invention and that different kinds of roping, e.g. a 2:1 roping or a 4:1 roping may be used as well.

The tension member 3 may be a rope, e.g. a steel wire rope, or a belt. The tension member 3 may be uncoated or may have a coating, e.g. in the form of a polymer jacket. In a particular embodiment, the tension member 3 may be a belt comprising a plurality of polymer coated steel cords (not shown). The elevator system 2 may have a traction drive including a traction sheave for driving the tension member 3. In an alternative configuration, which is not shown in the figures, the elevator system 2 may be an elevator system 2 without a tension member 3.

The elevator system 2 also may comprise e.g. a hydraulic drive or a linear drive. The elevator system 2 may have a machine room (not shown) or it may be a machine room-less elevator system 2.

The elevator system 2 further includes a counterweight 19 attached to the tension member 3 and configured for moving concurrently and in opposite direction with respect to the elevator car 60 along at least one counterweight guide member 15. The skilled person will understand that the invention may be applied also to elevator systems 2 which do not comprise a counterweight 19.

Each landing 8 is provided with a landing door 11, and the elevator car 60 is provided with a corresponding elevator car door 12 for allowing passengers to transfer between a landing 8 and the interior of the elevator car 60 when the elevator car 60 is positioned at the respective landing 8.

The drive unit 5 is controlled by an elevator control unit (not shown) for moving the elevator car 60 along the hoistway 4 between the different landings 8.

Input to the elevator control unit may be provided via landing control panels 7a, which are provided on each landing 8 close to the landing doors 11, and/or via an elevator car control panel 7b, which is provided inside the elevator car 60.

The landing control panels 7a and the elevator car control panel 7b may be connected to the elevator control unit by means of electric wires, which are not shown in FIG. 1, in particular by an electric bus, or by means of wireless data connections.

The elevator car 60 is equipped with at least one elevator safety device 20, which is schematically illustrated at the elevator car 60 in FIG. 1. Alternatively or additionally, the counterweight 19 may be equipped with at least one elevator safety device 20. An elevator safety device 20 attached to the counterweight 19, however, is not shown in FIG. 1.

The elevator safety device 20 is operable to brake or at least assist in braking (i.e. slowing or stopping the movement) of the elevator car 60 relative to a car guide member 14 by engaging with the car guide member 14.

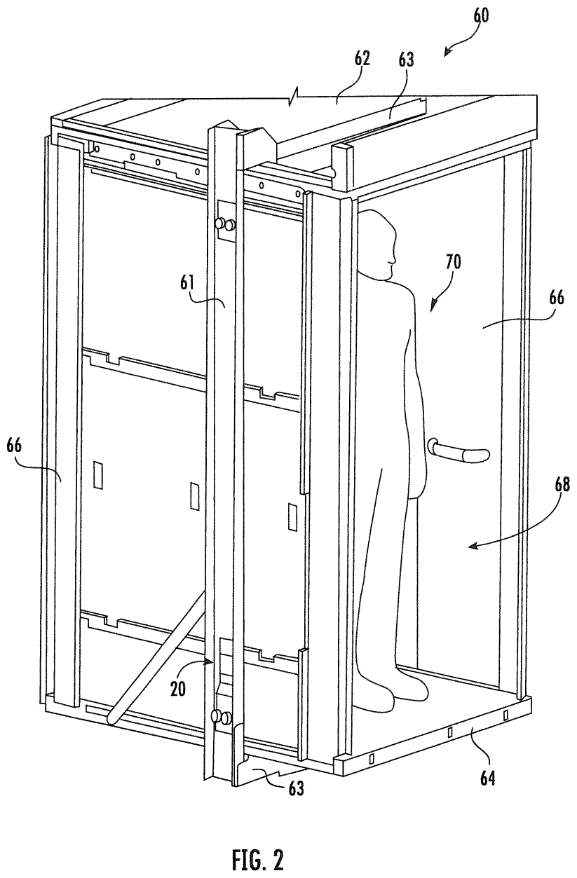

FIG. 2 is an enlarged perspective view of an elevator car 60 according to an exemplary embodiment of the invention. The elevator car 60 comprises a structural frame comprising vertically extending uprights 61 and crossbars 63 extending horizontally between the uprights 61. Only one upright 61 is visible in FIG. 2.

The elevator car 60 further includes a car roof 62, a car floor 64 and a plurality of car side walls 66. In combination, the car roof 62, the car floor 64 and the plurality of side walls 66 define an interior space 68 for accommodating and carrying passengers 70 and/or cargo (not shown).

An elevator safety device 20 according to an exemplary embodiment of the invention is attached to an upright 61 of the elevator car 60.

Although only one elevator safety device 20 is depicted in FIGS. 1 and 2, respectively, the skilled person will understand that a plurality of elevator safety device assemblies 20 may be mounted to a single elevator car 60. In particular, in a configuration in which the elevator system 2 comprises a plurality of car guide members 14, an elevator safety device 20 may be associated with each car guide member 14.

Alternatively or additionally, two or more elevator safety devices 20 may be provided on top of each other at the same upright 61 of the elevator car 60 in order to engage with the same car guide member 14.

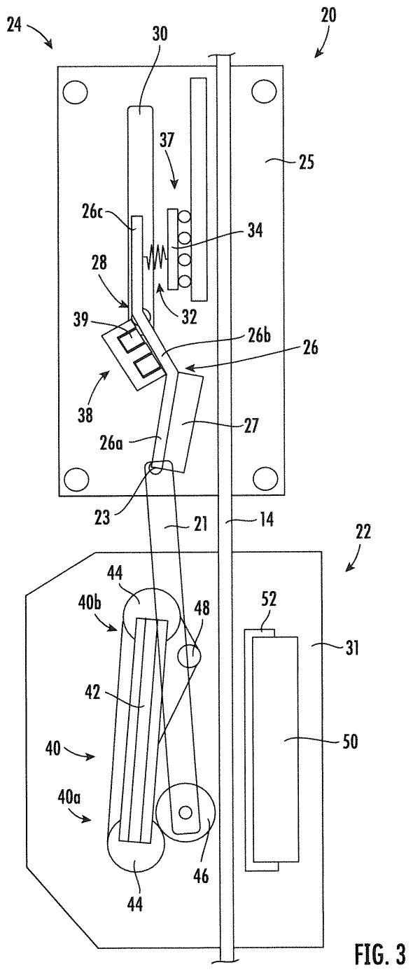

In the following, the configuration and the operating principle of elevator safety devices 20 according to exemplary embodiments of the invention are described. FIG. 3 shows a plane view of the elevator safety device 20 according to an embodiment of the invention comprising an actuation device 24 and a braking device 22 in a disengaged (released) state.

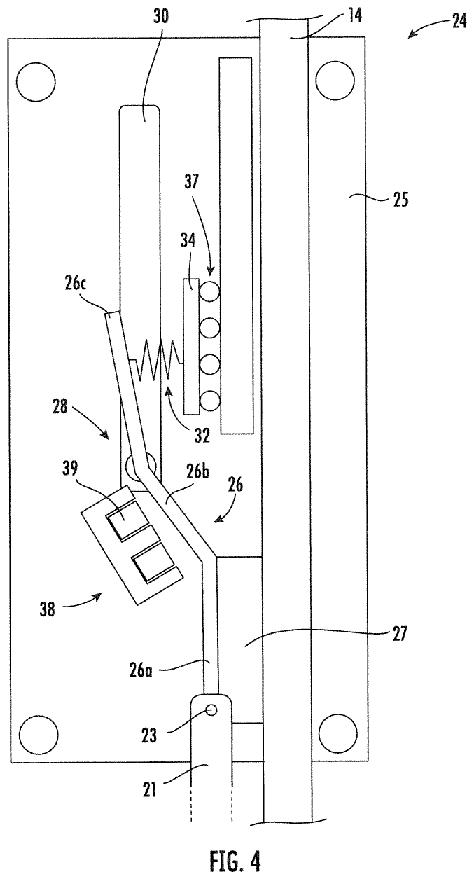

FIG. 4 shows a plane view of the actuation device 24 of the elevator safety device 20 in an engaged (activated) state. The braking device 22 is not depicted in FIG. 4.

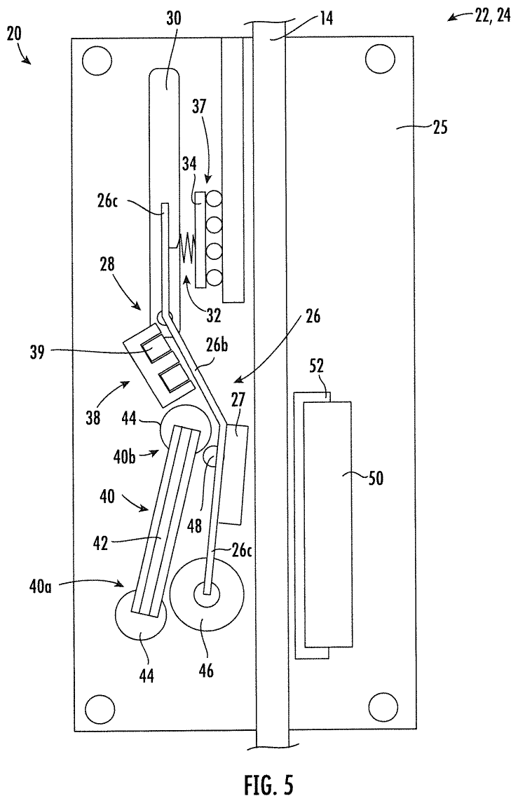

In the exemplary embodiment depicted in FIG. 3, the braking device 22 and the actuation device 24 are spaced apart from each other in the longitudinal direction along the car guide member 14. However, other spatial arrangements of the braking device 22 and the actuation device 24 are possible as well. The braking device 22 and the actuation device 24 in particular may be integrated with each other forming a combined actuation and braking device 22, 24. Such an integrated configuration is described further below with reference to FIG. 5.

In the embodiment depicted in FIG. 3, the braking device 22 and the actuation device 24 are mechanically connected with each other by an actuation rod 21 extending along the longitudinal direction, i.e. basically parallel to the car guide member 14. The actuation device 24 is configured for actuating the braking device 22 via the actuation rod 21.

The actuation device 24 comprises a base 25 and a lever 26 including three legs 26a, 26b, 26c. The lever 26 in particular comprises a first (lower) leg 26a, which is pivotably connected with the actuation rod 21 at a joint 23, a second (middle) leg 26b extending from an end of the first leg 26a opposite to the actuation rod 21, and a third (upper) leg 26c extending from an end of the second leg 26b opposite to the first leg 26a. In the embodiment depicted in the figures, the first, second and third legs 26a, 26b, 26c are inclined with respect to each other resulting in an s-shape of the lever 26. This, however, is only an exemplary configuration, and the skilled person understands that other geometrical shapes of the lever 26 are possible as well.

A friction lining 27 is provided on a side of the first lever 26a facing the car guide member 14.

At the interface between the second and third legs 26b, 26c, the lever 26 is pivotably supported by a fulcrum 28 allowing the lever 26 to pivot between a disengaged position, as it is depicted in FIG. 3, and an engaged position, as it is depicted in FIG. 4.

When the lever 26 is arranged in the disengaged position, the friction lining 27 does not contact the car guide member 14. When the lever 26 is arranged in the engaged position, the friction lining 27 contacts the car guide member 14.

An elastic element 32, such as a spring, abuts to the third leg 26c of the lever 26. The elastic element 32 is configured for urging the lever 26 into the engaged position.

The actuation device 24 further comprises an actuator 38 configured for moving and/or holding the lever 26 into/in the disengaged position. The actuator 38 in particular comprises at least one electromagnet 39, which is configured for generating an electromagnetic force attracting the second leg 26b of the lever 26 when it is energized. For being attracted by the at least one electromagnet 39, at least a sufficient part of the second leg 26b of the lever 26 is made of a magnetic material, such as metal, or at least a piece of such a magnetic material is attached to the second leg 26b.

Optionally, all legs 26a, 26b, 26c of the lever 26 may be made of a magnetic material, in particular of a metal. The legs 26a, 26b, 26c of the lever 26 in particular may be formed integrally with each other by bending an appropriate piece of metal into the desired shape.

The fulcrum 28 is shiftably supported by the base 25, e.g. by a rail or a slot 30 formed at the base 25. The fulcrum 28 in particular is supported by the base 25 in a configuration which allows the fulcrum 28, and in consequence the lever 26, to shift linearly in the longitudinal direction, i.e. parallel to the extension of the car guide member 14.

While a first end of the elastic element 32 abuts the third leg 26c of the lever 26, an opposing second end of the elastic element 32 is movably, in particular shiftably, supported by the base 25. The second end of the elastic element 32 in particular may be fixed to a carriage 34, which is linearly shiftable with respect to the base 25 in the longitudinal direction. The carriage 34 may be supported in a configuration in which it is shiftable, in particular linearly shiftable, with respect to the base 25 by at least one roller bearing 37 or by a slide bearing (not shown).

As a result, the lever 26 and the elastic element 32 are shiftable concurrently along the longitudinal direction.

During normal operation of the elevator system 2, i.e. when the elevator safety device 20 is not activated, the actuator 38 is energized for holding the lever 26 in the disengaged position, as it is depicted in FIG. 3.

For activating the elevator safety device 20, the actuator 38 is deenergized, i.e. the supply of electrical power to the actuator 38 is switched-off. As a result, the actuator 38 does not hold the lever 26 in the disengaged position anymore, but the elastic element 32 urges the lever 26 into the engaged position, as it is depicted in FIG. 4.

When the lever 26 is arranged in the engaged position, the friction lining 27 contacts the car guide member 14. When the elevator car 60 and in consequence the elevator safety device 20 attached to the elevator car 60 are moving along the car guide member 14 in the longitudinal direction, frictional forces generated between the friction lining 27 and the car guide member 14 cause the lever 26 to move with respect to the base 25 in the longitudinal direction.

In particular, when the elevator car 60 and the elevator safety device 20 are moving downwards along the car guide member 14, the car guide member 14 moves upwards with respect to the base 25. The frictional force generated between the friction lining 27 and the car guide member 14 brakes the downward movement of the lever 26. As a result, when viewed from the perspective of the base 25, which is fixed to the elevator car 60 moving downwards, the lever 26 is pulled upwards.

The movably supported carriage 34 attached to the second end of the elastic element 32, allows the elastic element 32 to move upwards concurrently with the lever 26 with respect to the base 25, thereby maintaining the elastic force urging the friction lining 27 against the car guide member 14.

As a result of said upward movement of the lever 26, the actuation rod 21 is pulled upwards by the lever 26 with respect to the base 25.

In other words, when viewed from outside the elevator car 60, the base 25 and the braking device 22 move downwards with respect to the lever 26 and the actuation rod 21, when the elevator car 60 moves downwards along the car guide member 14 while the lever 26 is arranged in its engaged position.

A roller 46 is rotatably mounted to a (lower) end of the actuation rod 21 opposite to the (upper) end of the actuation rod 21 connected with the lever 26 by the joint 23.

The braking device 22 (see FIG. 3) comprises a guide 40 located next to the actuation rod 21 on a side opposite to the car guide member 14, i.e. on the left side of the actuation rod 21 in the orientation of the braking device 22 depicted in FIG. 3.

The guide 40 is arranged in an inclined orientation with respect to the longitudinal direction, so that the distance between a lower end 40a of the guide 40 and the car guide member 14 is larger than the distance between an upper end 40b of the guide 40 and the car guide member 14.

The guide 40 may be formed integrally with or mounted to a safety block 31 of the braking device 22.

A brake pad 50 comprising a brake lining 52 facing the car guide member 14 is arranged on the other side of the car guide member 14, i.e. on the side of the car guide member 14 opposite to the actuation rod 21, so that the car guide member 14 is arranged in between the actuation rod 21 and the brake pad 50. The brake pad 50 is oriented basically parallel to the car guide member 14.

When the actuation rod 21 is pulled upwards with respect to the base 25 by the lever 26 of the actuation device 24, as it has been described before, the roller 46 mounted to the actuation rod 21 moves upwards along the guide 40.

Due to the inclined orientation of the guide 40, the roller 46 simultaneously moves towards the car guide member 14 until it contacts the car guide member 14.

As soon as the roller 46 contacts the car guide member 14, any further upward movement of the roller 46 causes the car guide member 14 to be squeezed between the roller 46 and the brake pad 50, in particular between the roller 46 and the brake lining 52 of the brake pad 50. Said squeezing generates a frictional force braking the movement of the elevator safety device 20 and in consequence also the movement of the elevator car 60 along the car guide member 14.

The inclined orientation of the guide 40 constitutes a wedge like configuration causing the frictional force generated by squeezing the car guide member 14 between the roller 46 and the brake pad 50 to increase concurrently with the roller 46 moving along the guide 40.

As, in general, the friction between the roller 46 and the car guide member 14 differs from the friction between the roller 46 and the guide 40, the roller 46, in general, is rotated by the difference of the frictional forces (“differential frictional force”) acting on both sides of the roller 46 as soon as the roller 46 touches both, the guide 40 and the car guide member 14. Thus, the rolling capability of the roller 46 allows compensating any differential frictional forces, which otherwise undesirably would act as shear forces and/or as torsional forces onto the element or portion of the actuation rod 21 being squeezed between the guide 40 and the car guide member 14 instead of the roller 46.

A roller stopper 48 is provided at an upper end of the guide 40 in order to prevent the roller 46 from moving beyond said upper end of the guide 40.

At least a portion of the guide 40 may have elastic properties causing a smooth engagement of the brake pad 50, in particular of the friction lining 52, with the car guide member 14. The guide 40 for example may comprise a leaf spring 42, which is configured for guiding the roller 46 and supported by at least two supports 44.

Another example of a self-locking braking device 22 as it may be employed in combination with an actuation device 24 according to an exemplary embodiment of the invention is described in detail in the European patent application 17 192 555.5.

An embodiment of an elevator safety device 20 according to yet another exemplary embodiment of the invention is depicted in FIG. 5.

In the exemplary embodiment depicted in FIG. 5, the elevator safety device 20 comprises an actuation device 24 including a linearly movable lever 26 similar to the actuation device 24 depicted in FIGS. 3 and 4.

Elements of the actuation device 24 corresponding to the elements of the actuation device 24 depicted in FIGS. 3 and 4 are denoted with the same reference signs, and identical structures and functionalities of the actuation device 24 are not discussed in detail again.

In the embodiment depicted in FIG. 5, the braking device 22 is integrated with the actuation device 24 forming only a single component and resulting in a more compact structure of the elevator safety device 20.

In the embodiment depicted in FIG. 5, the combined actuation and braking device 22, 24 comprises a guide 40 located next to the first leg 26a of the lever 26 on a side opposite to the car guide member 14, i.e. on the left side of the first leg 26a in the orientation of the elevator safety device 20 depicted in FIG. 5.

The guide 40 is arranged in an inclined orientation with respect to the longitudinal direction, so that the distance between a lower end 40a of the guide 40 and the car guide member 14 is larger than the distance between an upper end 40b of the guide 40 and the car guide member 14.

The guide 40 may be formed integrally with or mounted to the base 25.

Further, instead of being linked via an actuation rod 21 to the lever 26, the roller 46 is rotatably mounted to the first leg 26a of the lever 26, in particular to an end of the first leg 26a opposite to the second leg 26b.

A brake pad 50 with a brake lining 52 is arranged on the other side of the car guide member 14, i.e. on the side of the car guide member 14 opposite to the lever 26, so that the car guide member 14 is arranged between the lever 26 and the brake pad 50. The brake pad 50 is oriented basically parallel to the car guide member 14.

When the lever 26 moves upwards with respect to the base 25, as it has been described before with reference to FIGS. 3 and 4, the roller 46 mounted to the first lever leg 26a of the lever moves upwards along the guide 40 thereby rolling along the guide 40.

Due to the inclined orientation of the guide 40, the roller 46 simultaneously moves towards the car guide member 14 until it contacts the car guide member 14.

As soon as the roller 46 contacts the car guide member 14, any further upward movement of the roller 46 causes the car guide member 14 to be squeezed between the roller 46 attached to the first leg 26a of the lever 26 and the brake pad 50, in particular between the roller 46 and the brake lining 52 of the brake pad 50. Said squeezing generates a frictional force braking the movement of the elevator safety device 20 and in consequence also the movement of the elevator 60 along the car guide member 14.

The inclined orientation of the guide 40 constitutes a wedge like configuration causing the frictional force generated by sandwiching and squeezing the car guide member 14 between the friction lining 27 attached to the first leg 26a of the lever 26 and the brake pad 50 to increase concurrently with the roller 46 moving along the guide 40.

As, in general, the friction between the roller 46 and the car guide member 14 differs from the friction between the roller 46 and the guide 40, the roller 46, in general, is rotated by the difference of the frictional forces (“differential frictional force”) acting on both sides of the roller 46 as soon as the roller 46 touches both, the guide 40 and the car guide member 14. Thus, the rolling capability of the roller 46 allows compensating any differential frictional forces, which otherwise undesirably would act as shear forces and/or as torsional forces onto the element or portion of the lever 26 being squeezed between the guide 40 and the car guide member 14 instead of the roller 46.

Depending on the dimensions of the lever 26, the friction lining 27 and the roller 46, it is possible that the friction lining 27 is lifted from the car guide member 14 when the roller 46 contacts the car guide member 14. However, as soon as the roller 46 contacts the car guide member 14, a frictional force, which is sufficiently large for causing the lever 26 to continue moving upwards with respect to the base 25, is generated by the friction between the roller 46 and the car guide member 14.

In an alternative configuration, which is not depicted in the figures, the friction lining 27 may be omitted. In such a configuration, the lever 26 and the roller 46 are designed so that the roller 46 touches the car guide member 14 generating a frictional force, which is sufficiently large for moving the lever 26 upwards with respect to the base 25, as soon as actuator 38 is deenergized and the lever 26 is moved into its engaged position by the elastic force provided by the elastic element 32.

A roller stopper 48 is provided at the upper end of the guide 40 in order to prevent the roller 46 from moving beyond said upper end of the guide 40.

At least a portion of the guide 40 may have elastic properties resulting in a smooth engagement of the friction lining 27 with the car guide member 14. The guide 40 for example may comprise a leaf spring 42, which is configured for guiding the roller 46 and supported by at least two supports 44 extending from the base 25.

The elevator safety devices 20 described with reference to FIGS. 3 to 5 are configured for braking downward movements of the elevator car 60 corresponding to upward movements of the car guide member 14 with respect to the base 25.

The skilled person understands that a similar elevator safety device 20, in particular an elevator safety device 20 basically oriented in an upside down configuration as compared to the embodiments depicted in FIGS. 3 to 5, may be employed for braking upward movements of the elevator car 60, i.e. movements of the elevator car 60 corresponding to downward movements of the car guide member 14 with respect to the base 25.

Although only elevator safety devices 20 attached to the elevator car 60 have been described with reference to FIGS. 3 to 5, the skilled person understands that elevator safety devices 20 according to exemplary embodiments of the invention may also be mounted to the counterweight 19 (if present) for interacting with the counterweight guide member 15.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 drive unit
7a landing control panel
7b elevator car control panel
8 landing
11 landing door
12 elevator car door
14 car guide member
15 counterweight guide member
19 movable component/counterweight
20 elevator safety device
21 actuation rod
22 braking device
23 joint
24 actuation device
25 base
26 lever
26a first leg of the lever
26b second leg of the lever
26c third leg of the lever
27 friction lining
28 fulcrum
30 rail/slot
31 safety block
32 elastic element
34 carriage
37 roller bearing
38 actuator
39 electromagnet
40 guide
40a lower end of the guide
40b upper end of the guide
42 leaf spring
44 supports
46 roller
48 roller stopper
50 brake pad
52 brake lining
60 movable component/elevator car
61 upright
62 car roof
63 crossbar
64 car floor
66 car side wall
68 interior space of the elevator car
70 passenger

What is claimed is:

1. Actuation device (24) for an elevator safety device (20) configured for moving in a longitudinal direction along a guide member (14, 15) of an elevator system (2), the actuation device (24) comprising:
a base (25);
a lever (26) pivotably supported by the base (25) in a configuration allowing the lever (26) to pivot between an engaged position, in which at least a portion of the lever (26) or an element (27, 46) moving concurrently with the lever (26) contacts the guide member (14, 15); and a disengaged position, in which neither the lever (26) nor an element (27, 46) moving concurrently with the lever (26) contacts the guide member (14, 15);
wherein the lever (26) is shiftable with respect to the base (25).

2. Actuation device (24) according to claim 1, wherein the lever (26) is supported by a fulcrum (28) which is linearly shiftable with respect to the base (25), in particular in a direction oriented basically parallel to the longitudinal direction.

3. Actuation device (24) according to claim 1, further comprising at least one elastic element (32) configured for urging the lever (26) into the engaged position.

4. Actuation device (24) according to claim 3, wherein a first end of the elastic element (32) is mounted to the lever (26), and a second end of the elastic element (32) is mounted to a carriage (34) which is movable with respect to the base (25).

5. Actuation device (24) according to claim 4, further comprising a roller bearing (37) or a slide bearing which is configured for supporting the carriage (34) in a configuration allowing the carriage (34) to move with respect to the base (25).

6. Actuation device (24) according to claim 1, further comprising at least one actuator (38), in particular an actuator (38) comprising at least one electromagnet (39), configured for selectively moving and/or holding the lever (26), in particular for moving and/or holding the lever (26) into/in the disengaged position.

7. Elevator safety device (20) configured for moving along a guide member (14, 15) of an elevator system (2), the elevator safety device (20) comprising an actuation device (24) according to claim 1 and a braking device (22) coupled with the actuation device (24) and configured for braking movement of the elevator safety device (20) with respect to the guide member (14, 15), wherein the actuation device (24) is configured for actuating the braking device (22).

8. Elevator safety device (20) configured for moving along a guide member (14, 15) of an elevator system (2), the elevator safety device (20) comprising an actuation device (24) according to claim 1 and at least one guide (40) configured for pressing a portion of the lever (26) against the guide member (14, 15) when the lever (26) is arranged in the engaged position and the elevator safety device (20) moves with respect to the guide member (14, 15).

9. Elevator safety device (20) according to claim 8, wherein the at least one guide (40) extends in a direction which is inclined with respect to the longitudinal direction.

10. Elevator safety device (20) according to claim 8, further comprising a roller (46) rotatably attached to the lever (26) and configured for rolling along the at least one guide (40).

11. Elevator safety device (20) according to claim 10, wherein the at least one guide (40) comprises an elastic element (32), in particular a leaf spring, configured for elastically pressing the roller (46) against the at least one guide (14).

12. Elevator safety device (20) according to claim 8, further comprising a brake pad (50) arranged in a configuration which allows sandwiching the guide member (14, 15) between the element (27, 46) moving concurrently with the lever (26) and the brake pad (50) by moving the lever (26) into the engaged position.

13. Elevator safety device (20) according to claim 12, wherein a brake lining (52) is applied at least to the side of the brake pad (50) facing the guide member (14, 15).

14. Movable component (19, 60), in particular an elevator car (60) or a counterweight (19), of an elevator system (2) comprising an elevator safety device (20) according to claim 7.

15. Elevator system (2) comprising a movable component according to claim 13, wherein the movable component (19, 60) is configured for traveling a hoistway (4) between a plurality of landings (8).
